(19) United States
(12) Patent Application Publication
(10) Pub. No.: US 2026/0185969 A1
(43) Pub. Date: Jul. 2, 2026

(54) MINIATURIZED CHROMATOGRAPHIC METHOD, RELATED USES, AND AUTOMATED MULTIDIMENSIONAL SOLID-PHASE EXTRACTION CHROMATOGRAPHIC SYSTEM

(71) Applicants: PETRÓLEO BRASILEIRO S.A. - PETROBRAS, Rio de Janeiro (BR); UNIVERSIDADE FEDERAL DE GOIÁS - UFG, Goiania (BR)

(72) Inventors: RODRIGO CABRAL DA SILVA, Rio de Janeiro (BR); ALEXANDRE DE ANDRADE FERREIRA, Rio de Janeiro (BR); NERILSON MARQUES LIMA, Goiânia (BR); JOVEILTON BATISTA DA SILVA JUNIOR, Goiânia (BR); YGOR DOS SANTOS ROCHA, Rio de Janeiro (BR); GESIANE DA SILVA LIMA, Goiânia (BR); ANDRÉA RODRIGUES CHAVES, Goiânia (BR); GABRIEL FRANCO DOS SANTOS, Goiânia (BR); BONIEK GONTIJO VAZ, Goiânia (BR)

(73) Assignees: PETRÓLEO BRASILEIRO S.A. - PETROBRAS, Rio de Janeiro (BR); UNIVERSIDADE FEDERAL DE GOIÁS - UFG, Goiania (BR)

(21) Appl. No.: 19/425,194

(22) Filed: Dec. 18, 2025

(30) Foreign Application Priority Data
Dec. 30, 2024 (BR) 1020240275187

(51) Int. Cl. G01N 30/72; G01N 30/02; G01N 30/14; G01N 30/88

(52) U.S. Cl. CPC G01N 30/7266; G01N 30/14; G01N 30/88; G01N 2030/027; G01N 2030/8854

(57) ABSTRACT

One objective of the present invention is to provide a miniaturized chromatographic method for the selective extraction of polar compounds from crude oils, which is faster and more economical in terms of sample consumption, solvent volume, and waste generation, without compromising the chemical signature of the sample. Specifically, the method employed was solid-phase extraction (SPE), in online and offline modes, for the prospecting of polar compounds from crude oils, together with H-MPLC, in order to support a greater understanding of petroleum systems through the development of faster, more selective, economical, and environmentally more sustainable analytical and chromatographic methods. Furthermore, the invention also provides to describe an automated multidimensional solid-phase extraction (SPE) chromatographic system, which is applied in said method, as well as to describe some uses of said method.

### CROSS-REFERENCE TO RELATED APPLICATION

This application claims benefit to Brazilian Application No. BR 1020240275187, filed on on Dec. 30, 2024, which is hereby incorporated by reference in its entirety.

### FIELD

The present invention relates to methods of extraction and purification of compounds in complex matrices, more specifically in analytical sample preparation techniques, such as solid-phase extraction (SPE) and miniaturization of chromatographic fractionations. These techniques aim to optimize the efficiency of chemical analysis, focusing on improving speed, accuracy, economy, and sustainability in the use of solvents and materials, especially in processes involving the separation of compounds from complex mixtures, such as crude oils.

Therefore, the field of the invention is focused on analytical chemistry and sample separation and purification technology, with applications in several industries, such as petroleum, pharmaceutical, food, and environmental.

### BACKGROUND

Medium pressure liquid chromatography (MPLC), developed in 1970 for the analysis of organic compounds, is a branch of preparative liquid chromatography that uses chromatographic columns on a preparative scale, but with particles of smaller diameters than traditional ones (Hostettmann, K. and Terreaux, C. Encyclopedia of Separation Science, 2000, 3296 to 3303). The MPLC technique has been employed for separation, fractionation and cleaning of different samples since its introduction.

However, it was only in 1980 that it was applied to geochemical analyses in samples of crude oils and organic matter, especially for the extraction and characterization of polar compounds in these matrices (Matthias, R.; Helmut, W.; Welte, D. H; Preparative hydrocarbon group type determination by automated medium pressure liquid chromatography, Analytical Chemistry, 1980, 52 (3): 406 to 11).

Although the technique is currently well established for the fractionation of crude oils and is always mentioned for its high efficiency and low cost (Covas, T. R. et al., Fractionation of polar compounds from crude oils by heteromedium pressure liquid chromatography (H-MPLC) and molecular characterization by ultrahigh-resolution mass spectrometry, Fuel 267 2020, 117289), some necessary procedures have been adopted for its satisfactory execution, making it obsolete and time-consuming compared to more efficient and modern analytical systems and methods, with higher analytical frequency and a marked reduction in generated waste.

In addition to the disadvantages already mentioned, it can also be added: the low reproducibility of this technique, since there are variations resulting from the manufacture of the chromatographic columns used and heterogeneity of the stationary phases; the moderate chromatographic resolution power and the need to collect the fractions for subsequent analysis, reducing their reproducibility and repeatability; the high volume of sample and solvents required in order to obtain adequate fractionation; and the incompatibility of hyphenation with more sensitive detection systems, such as mass spectrometry. Thus, all these disadvantages contribute to making separation expensive and time-consuming.

In this way, it becomes imperative to develop methods that seek to overcome these limitations. Solid-phase extraction (SPE) presents itself as a promising alternative, aiming to contribute to the higher analytical frequency by providing fast and accurate answers, possessing technologies that allow the use of hyphenated analysis systems.

Geochemical analyses of petroleum have traditionally been conducted by characterizing the nonpolar fraction of crude oils using gas chromatography [(Kim, E.; Cho, E.; Moon, S.; Park, J.-L; Kim, S. Characterization of Petroleum Heavy Oil Fractions Prepared by Preparatory Liquid Chromatography with Thin-Layer Chromatography, High-Resolution Mass Spectrometry, and Gas Chromatography with an Atomic Emission Detector, Energy and Fuels, 2016, 30 2932 to 2940); Pollo, B. J.; Alexandrino, G. L.; Augusto, F. Hantao, L. W. The impact of comprehensive two-dimensional gas chromatography on oil & gas analysis: Recent advances and applications in petroleum industry, Trends in Analytical Chemistry, 2018, 105, 202 to 217)]. However, identifying polar compounds that can complement numerous geochemical interpretations is not easily accessible using such analytical techniques.

Despite advances in petroleonomic approaches in the organic geochemistry of petroleum, challenges still exist, especially due to contaminants and fluids used in drilling and production. One solution would be to use standardized petroleum fractions, mainly from the polar part, to build classification models.

The fractionation of polar substances by medium-pressure liquid chromatography (MPLC) is promising because it generates highly reproducible petroleum fractions and is routinely used in geochemistry. MPLC, which uses multiple preparative columns, simplifies the analysis of complex samples, but further studies are needed to improve its performance, reduce costs and analysis time, and minimize waste generation [(Willsch, H.; Clegg, H.; Horsfield, B.; Radke, M.; Wilkes, H. Liquid Chromatographic Separation of Sediment, Rock, and Coal Extracts and Crude Oil into Compound Classes, Analytical Chemistry, 1997, 69, 4203 to 4209].

Solid-phase extraction (SPE) is a widely used sample preparation technique for extraction, reconcentration of analytes and sample cleanup. This technique has the advantage of a high number of commercially available extraction phases, allowing selectivity to be modified not only by changing the eluent, but also by altering the functional groups available in the solid phase. In general, modified silica is the most commonly used phase, but organic polymeric materials, monoliths and specific recognition materials also have been employed. Another advantage can be attributed to the possibility of performing sequential SPE extractions, offline, with the collection of the extract for subsequent analysis, or online, with the extraction system coupled to the analytical system.

When compared to the MPLC technique, SPE requires less solvent, employs less mass of extraction phase, requiring a smaller sample volume. Furthermore, the ease of coupling with the analytical system can also be highlighted, which is a major limitation of the MPLC technique. Thus, applying the principles of separation already well established in the fractionation of crude oils by MPLC, such as stationary phases and elution solvents on a reduced scale as in the SPE technique, would provide a reduction in consumed inputs and generated waste, adding greater analytical frequency with more efficient separations.

Therefore, there is significant interest in the development of new selective and sensitive techniques to extract and purify compounds from complex matrices. It is known that an ideal sample extraction method should be fast, accurate, economical, to utilize low-cost materials, offer high yield, and require minimal solvent consumption (Rodriguez-Mozaz, S.; de Alda, M. J. L.; Barceló, D. Advantages and limitations of on-line solid phase extraction coupled to liquid chromatography-mass spectrometry technologies versus biosensors for monitoring of emerging contaminants in water, Journal of Chromatography A, 2007, 1152, 97 to 115).

In this context, Solid Phase Extraction (SPE) represents a valuable separation technique, as it provides high reproducibility, fast and economical analysis, reduced waste generation, and minimal sample and solvent requirements (Rodriguez-Mozaz, S.; de Alda, M. J. L.; Barceló, D. Advantages and limitations of on-line solid phase extraction coupled to liquid chromatography-mass spectrometry technologies versus biosensors for monitoring of emerging contaminants in water, Journal of Chromatography A, 2007, 1152, 97 to 115). These requirements for sample extraction can be met through the automation of analytical methods and the online coupling of sample preparation with separation and detection systems.

Online SPE offers automated sample pretreatment, reduces time and complexity compared to offline methods, and allows for higher throughput and faster analysis [7]. SPE methods, particularly those with weak and strong anion exchange phases, have been widely adopted for the extraction of acidic species from crude oils.

However, the applications of SPE in crude oil analysis are limited and often focus on specific classes of compounds.

This is because most studies on SPE in the analysis of the polar fraction of crude oil are directed towards specific classes of compounds, especially acidic compounds, such as naphthenic acids, and the concentration of basic nitrogen compounds using ion-exchange chromatography (Vasconcelos, G. A.; Pereira, R. C.; Santos, C. D. F.; Carvalho, V. V.; Tose, L. V.; Romão, W.; Vaz, B. G. Extraction and fractionation of basic nitrogen compounds in vacuum residue by solid-phase extraction and characterization by ultra-high resolution mass spectrometry. International Journal of Mass Spectrometry, 2017, 418, 67 to 72). In addition, additional separation strategies are often necessary.

For example, Jones and colleagues (Jones, D. M.; Watson, J. S.; Meredith, W.; Chen, M.; Bennett, B. Determination of naphthenic acids in crude oils using nonaqueous ion exchange solid-phase extraction, Analytical Chemistry, 2001, 73 (3):703 to 707) used SPE cartridges with an ion-exchange extraction phase to separate naphthenic acids in crude oil samples. They observed that a single phase was not sufficient for the complete extraction of the target compounds and, therefore, added a new fractionation step, resulting in naphthenic acid fractions with higher yield and a greater number of identified compounds.

Similarly, Rowland and colleagues (Rowland, S. M.; Robbins, W. K.; Corilo, Y. E.; Marshall, A. G.; Rodgers, R. P. Solid-phase extraction fractionation to extend the characterization of naphthenic acids in crude oil by electrospray ionization fourier transform ion cyclotron resonance mass spectrometry. Energy Fuels, 2014, 28 (8):5043 to 5048) used off-line SPE with aminopropyl silica as the extraction phase and a series of elutions with dichloromethane and methanol. The Authors applied different separation strategies, altering the composition of the elution solvents, but all strategies required additional fractionations before the final HRMS analysis for the determination of naphthenic acids.

Furthermore, many studies that use SPE in petroleum analysis employ the technique only as a cleanup method for application in hyphenated chromatographic techniques, such as SPE-GC-MS, and not as a chromatographic fractionation technique, being applied mainly for fingerprinting analysis of crude oils and refined petroleum products (Yang, Z.; Yang, C.; Wang, Z.; Hollebone, B.; Landriault. M.; Brown, C. E. Oil fingerprinting analysis using commercial solid phase extraction (SPE) cartridge and gas chromatography-mass spectrometry (GC-MS). Analytical Methods, 2011, 3 (3), 628 to 635).

The document CN 118225953 describes “Derivation and separation methods and analytical methods for carboxylic acid compounds in organic matter”. It belongs to the technical field of petroleum composition analysis and refers to a method for deriving and separating carboxylic acid compounds in organic matter and a method for analyzing carboxylic acid compounds in organic matter. It clarifies that a variety of modern advanced analytical techniques can analyze the composition of carboxylic acid compounds in complex organic systems, such as petroleum.

However, although the document CN 118225953 is related to petroleum analysis, it focuses specifically on the derivatization and separation of compounds of the carboxylic acid class in organic matter, using techniques and modifications distinct from those presented in the present patent application. While it uses silica gel modified with silver nitrate for separation, the present patent application shows an innovative and miniaturized method for selective extraction of polar compounds from crude oils by SPE, with a multidimensional approach that allows the speciation of different chemical classes in a single chromatographic analysis, in a short period and with minimal waste generation.

The document CN 117942952 describes a “Method for separating silica gel from silver nitrate thiol compounds in petroleum”. It belongs to the technical field of petroleum composition analysis. This document states that it is necessary to provide a method for separating mercaptan compounds—a class of sulfur-containing compounds that are widely present in petroleum and petroleum products and are more common in secondary processing products such as coke and catalytic cracking—in petroleum to meet the technical requirements for studying the chemical composition of mercaptans in petroleum.

However, the method in CN 117942952 focuses on the separation of mercaptans (isolation and separation of mercaptans, a specific class of sulfur compounds) using silica gel treated with silver nitrate, while the present invention is more comprehensive, aimed at the simultaneous extraction of several classes of polar compounds in petroleum, without the need for chemical derivatization. Furthermore, unlike the method proposed in CN 117942952, the chromatographic fractionation obtained by the method provided in the present invention allows obtaining acidic and basic fractions, for example, which concentrate specific classes that can be used to estimate geochemical processes, determine the origin, biodegradation, and formation mechanism of petroleum. In other words, it can be said that the method in CN 117942952 is highly specific for the desulfurization and analysis of mercaptans, while the present invention covers the extraction and analysis of several polar and acidic/basic fractions, without being restricted to a single type of compound.

The document BR PI 0925425-0 describes a “Device with a plurality of valves and pathways for controlling a manifold solid-phase extraction system”. This multi-valve, multi-path device allows simultaneous control of multiple extraction cartridges and discs in a manifold-type solid-phase extraction system. The system developed in BR PI 0925425-0 is compatible with complex matrices and allows coupling and has the same operating mold and dimensions as the manifold concept originally described in the document U.S. Pat. No. 4,810,471.

However, there is a fundamental difference in the structure and operation of the methods. For example, BR PI 0925425-0 focuses on a solid-phase extraction system that uses a manifold device to manage larger sample volumes and control the flow rate through a peristaltic pump. In contrast, the present invention is geared towards a miniaturized and specific chromatographic method for obtaining polar fractions from petroleum resin, employing SPE cartridges packed with functionalized silica gel and differentiated solvents. Furthermore, the device described in BR PI 0925425-0 does not address the crucial details of separating polar compounds from complex samples for application in the characterization of petroleum geological processes, which are the core of the present invention. Furthermore, while BR PI 0925425-0 offers a solid-phase extraction system with a broad and general application, including eluate control and large volume management, the present invention stands out by detailing a specific process for the separation and analysis of polar species in petroleum resin.

The abstract of the Article entitled “Characterization of naphthenic acids in thermally degraded petroleum by ESI (−)-FTICR MS and ¹H NMR after solid phase extraction (SPE) and liquid/liquid extraction” (ENERGY & FUELS, 2018, 32, 2878 to 2888) discusses a methodology aimed at analyzing naphthenic acids (NAs) present in crude oil and thermal degradation products, using solid-phase extraction (SPE) and liquid-liquid extraction (LLE) techniques. The analysis of these compounds is performed by ESI (−)-FT-ICR MS and ¹H NMR mass spectrometry, with emphasis on the efficiency of SPE compared to LLE and the influence of eluent phases on the detection of NAs. In contrast, the present invention is centered on the miniaturization of the solid-phase extraction (SPE) process specifically adapted to obtain fractions of different polarities and acid/base characteristics of crude oil as a replacement for the conventional MPLC analysis method, aiming at faster and more economical analyses in terms of sample consumption, solvent volume and waste generation.

It is observed that the documents from the state of the art do not describe or provide guidance on the extraction of polar compounds from crude oils (petroleum). Thus, there is a need for the provision of miniaturization methods for chromatographic fractionations of crude oils.

### SUMMARY

One objective of the present invention is to provide a miniaturized chromatographic method for the selective extraction of polar compounds in crude oils, which is faster and more economical in terms of sample consumption, solvent volume, and waste generation without compromising the chemical signature of the sample. Specifically, the method employed was solid-phase extraction (SPE), in online and offline modes, for prospecting polar compounds from crude oils, together with medium-pressure liquid heterochromatography (H-MPLC), in order to support a greater understanding of petroleum systems through the development of faster, more selective, economical, and environmentally more sustainable analytical and chromatographic methods.

Another objective of the invention is to describe an automated multidimensional solid-phase extraction (SPE) chromatographic system which is applied in said method.

Yet another objective of the invention is to describe the uses of said method.

### BRIEF DESCRIPTION OF THE DRAWINGS

For a better understanding of the nature and objectives of the present invention, in order to assist in identifying the main characteristics of the miniaturized chromatographic method by solid-phase extraction (SPE) for the selective extraction of polar compounds in crude oils, with its results and technical effects, the figures to which reference is made are presented below.

FIG. 1 shows a graph of the quantitative evaluation of the recovery of chromatographic fractionations obtained by SPE (left column) and H-MPLC (right column) techniques of crude oils S1, S2, S3, S4, S5, S6, S7, S8, S9 and S10.

FIG. 2 shows a graph of the evaluation of the repeatability of the method in the extraction of low polarity (BP), low-medium polarity (BMP), high-medium polarity (AMP), high polarity (AP), basic (BAS) and acidic (ACD) compounds using the online SPE technique with an average of five replicates of the S1 oil sample.

FIGS. 3A and 3B show a class distribution diagram by ESI (−) FT-ICR MS of five replicates of the SPE fractionation of the acidic fraction (FIG. 3A) and the low polarity fraction (FIG. 3B) of oil S1.

FIGS. 4A and 4B show an experimental setup used for the fractionation of polar compounds using offline SPE (manifold extraction—FIG. 4A) and online SPE (FIG. 4B).

FIG. 5 shows a schematic representation for the extraction of polar compounds from crude oil samples using the H-MPLC system and online SPE.

FIGS. 6A to 6C show a class distribution diagram for the 10 crude oils analyzed by ESI (±) FT-ICR MS (FIG. 6A and FIG. 6B, respectively) and APPI (+) FT-ICR MS (FIG. 6C).

FIGS. 7A to 7F show a distribution diagram of the classes in the acid polarity fractions (ACD—FIG. 7A), high polarity (AP—FIG. 7B), basic polarity (BAS—FIG. 7C), low polarity (BP—FIG. 7D), high-medium polarity (AMP—FIG. 7E), low-medium polarity (BMP—FIG. 7F) extracted by H-MPLC and SPE for S10 oil sample. The chromatographic fractionations obtained by SPE (left column) and H-MPLC (right column) are studied in each of FIGS. 7A to 7F.

### DETAILED DESCRIPTION

The present invention relates to a miniaturized solid-phase extraction method for chromatographic fractionations of crude oils, which is faster and more economical in terms of sample consumption, solvent volume and waste generation without compromising the molecular composition of the sample.

The invention consists of a miniaturized solid-phase extraction (SPE) method in an online or offline SPE instrument, which solves several limitations of current techniques for analyzing the polar fraction of petroleum. Conventional techniques for fractionating polar substances, such as medium-pressure liquid chromatography (MPLC), face significant challenges, including process complexity, prolonged analysis time, the need for packing stationary phase columns, and substantial waste and sample generation.

The chromatographic method uses solid-phase extraction (SPE) in a multidimensional configuration for the selective fractionation of compounds with different polarities and acid-base properties.

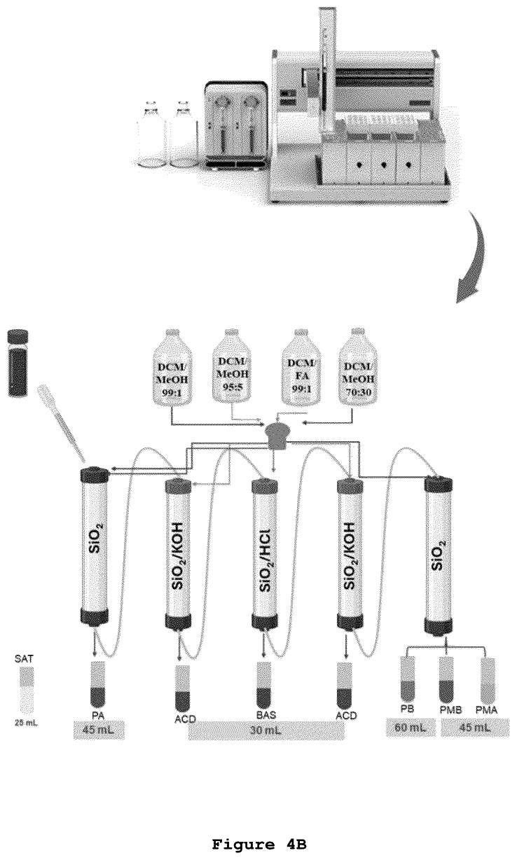

The sample, dissolved in n-hexane, is initially applied to a cartridge containing normal-phase silica for the separation of saturated compounds. Subsequently, the fractionation of polar compounds is performed using cartridges containing normal-phase silica and silica functionalized with HCl (acidic) and KOH (basic), arranged sequentially (FIG. 4B).

The process can be carried out either (i) offline, using a manifold device with the cartridges arranged in series, in a vertical configuration, or (ii) online, in an online SPE device with sequential and multi-position arrangement.

The non-functionalized silica cartridge, from which the saturated compounds were extracted, is sequentially coupled to cartridges containing basic silica (functionalized with KOH), acidic silica (functionalized with HCl), again basic silica (functionalized with KOH) and, finally, non-functionalized silica.

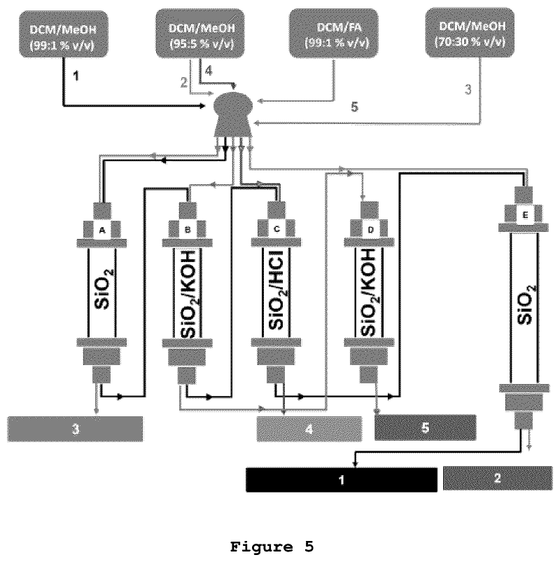

Elution occurs in distinct steps: low and low-medium polarity compounds extracted are with a dichloromethane/methanol mixture in a 99:1 ratio (FIG. 5—line 1), while high-medium polarity compounds are extracted sequentially with dichloromethane/methanol in a 95:5 ratio (FIG. 5—line 2); basic and acidic compounds are eluted directly from cartridges containing silica functionalized with HCl and KOH, using dichloromethane in neutral media (dichloromethane/methanol 95:5—FIG. 5—line 4) and acidic media (dichloromethane/formic acid 99:1—FIG. 5—line 5); finally, highly polar compounds are extracted with dichloromethane/methanol in a 7:3 ratio (FIG. 5—line 3).

The method results in six distinct fractions, encompassing compounds of different polarities and chemical properties, ensuring a fast, selective and efficient separation.

The invention was evaluated through several experiments that demonstrated its effectiveness in extracting polar compounds from crude oil samples.

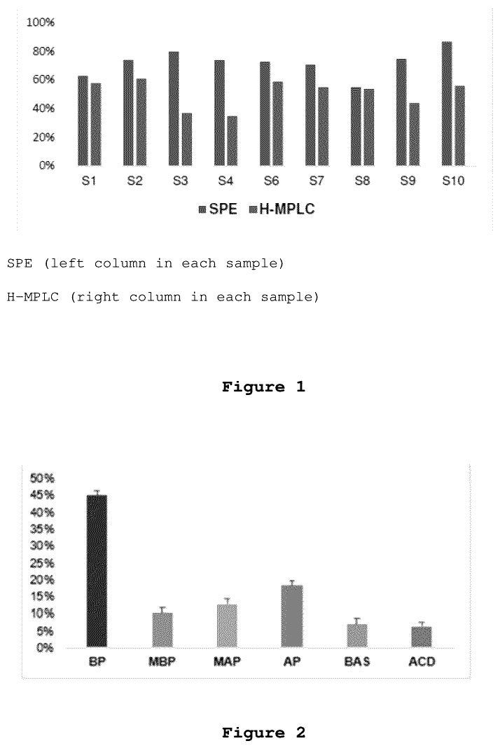

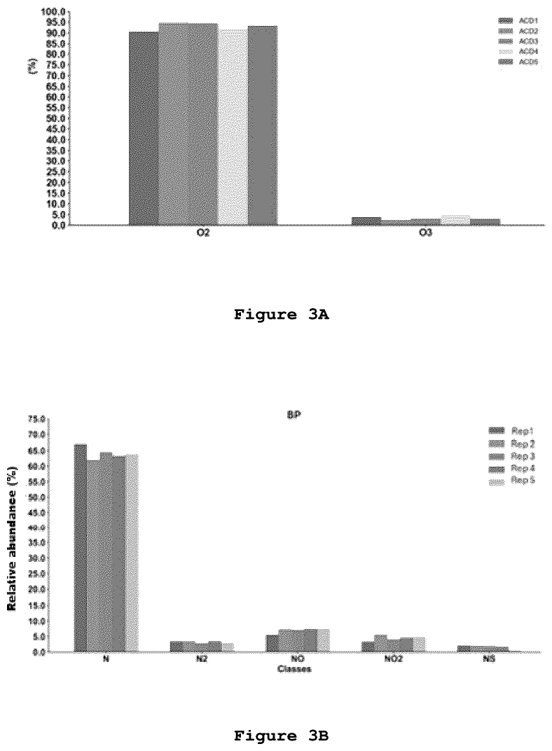

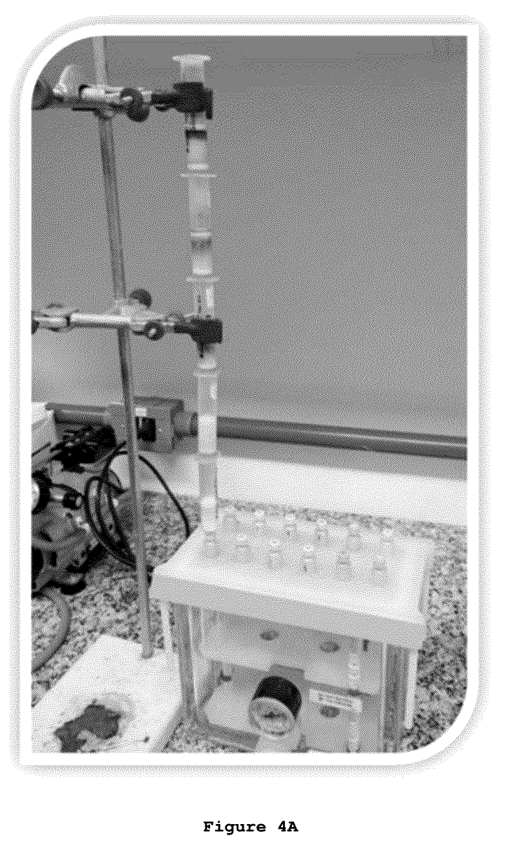

The SPE chromatographic fractionation methodology was compared with the traditional H-MPLC technique, and the results indicated that SPE maintains the quality of the analysis and offers several significant advantages, such as:
A) Higher Sample Recovery Efficiency—The SPE method demonstrated higher recovery efficiency, with rates between 55 to 87%, compared to 35 to 61% for H-MPLC (FIG. 1). This allows for more comprehensive approaches in terms of molecular composition and provides a more complete and accurate analysis of polar compounds, improving the reliability of the results.
B) Reduced Analysis Time—The optimized SPE method, using commercial cartridges, allowed the fractionation process to be completed in just 50 minutes. In contrast, the traditional HMPLC method required 1.5 to 2 hours to complete the same process. This allows for faster and more efficient analysis of samples, increasing productivity.
C) Cost and Waste Reduction—The automated SPE method using commercial cartridges allows the separation of classes of compounds with distinct physicochemical properties, such as polarity, molecular weight, acidity/basicity, and aliphatic/aromatic characteristics. This versatility in separation enhances the ability to perform detailed characterization of the polar fractions of petroleum and quantification of their polar constituents, offering valuable insights into petroleum geochemistry. The SPE method is more economical, reducing the consumption of solvents, samples, and silica by up to 75%. Furthermore, the application of the smaller-scale extraction process, developed by the present invention, results in smaller amounts of chemicals involved in laboratory manipulations, which ensures better control of contingency processes and less generation of toxic vapors and waste associated with the risk in the development of laboratory activities.
D) Reproducibility and High Precision—Experiments performed in quintuplicate with crude oil demonstrated high reproducibility and precision of the SPE method, extracting the same classes of compounds, with practically the same abundance, as MPLC. This ensures that the new technique maintains the integrity and quality of the analytical data. The average percentages of each fraction (BP, BMP, AMP, AP, BAS, and ACD) showed low standard deviations, indicating consistency and precision in the results (FIG. 2).
E) Separation of Polar Compounds—Studies have evaluated the efficiency of the SPE method in separating polar compounds (NSO). The results showed that SPE accurately reproduced the fractionation profiles obtained by H-MPLC, with differences in the abundance of chemical classes not exceeding 5% (FIG. 3). This confirms that SPE can be used effectively to separate and analyze polar compounds in crude oils.
F) Functionalization of SPE Cartridges (Elimination of the Need for Stationary Phase Packing)—One of the innovative aspects of the invention is the possibility of functionalizing commercial cartridges, avoiding the laborious process of chromatographic column packing, providing greater selectivity in the extraction of polar compounds. Furthermore, other separation mechanisms can be incorporated into the method for the selective separation of several classes of compounds, in addition to polarity and acid/base affinity separation mechanisms.
G) Simplicity and Accessibility—The use of vacuum manifold equipment for offline SPE further simplifies the process, making it more accessible and agile. This approach significantly reduces investments in infrastructure and maintenance compared to automated systems.

These examples demonstrate that the SPE technique can not only replace H-MPLC in several applications, but also offers substantial improvements in terms of efficiency, sustainability and time savings, making it a superior choice for the extraction and analysis of polar compounds from crude oils.

The main applications of the invention include:
1) Advanced Molecular Analysis—The SPE method allows the separation of classes of compounds with distinct physicochemical properties (polarity, molecular weight, acidity/basicity, aliphatic/aromatic chain) contributing to the identification and detailed characterization of polar compounds from oils from petroleum reservoirs, which are essential for geochemical interpretation, exploration strategies and understanding of the petroleum system.
2) Geochemical Characterization—The method can be applied to the geochemical characterization of petroleum systems, helping to separate, identify, and quantify organic compounds present in petroleum. This is essential for evaluating petroleum quality and determining its origin and thermal maturity.
3) Development of Classification Models—The standardized fractions obtained by SPE can be used to build petroleum classification models based on their molecular characteristics. This is useful for comparing different petroleum samples and for predicting the properties of new oil fields.
4) Operational Efficiency—The SPE method is faster (50 minutes versus almost two hours for MPLC), reducing analysis time and increasing operational efficiency. In addition, it eliminates the need for stationary phase packing, simplifying the analytical process.

Among the several applications of the present invention, mentioned above, the crucial application in the oil exploration and production (E&P) sector stands out, particularly in obtaining chromatographic fractions with distinct physicochemical properties that contribute to speciation and molecular analysis of oil and reservoir fluids, providing valuable information that can be applied in the characterization of geological processes and isolation of molecular markers.

Thus, the invention offers an efficient, economical and sustainable solution for the analysis of polar compounds in the organic geochemistry of petroleum, with applications ranging from improving E&P operations to contributing to more sustainable practices in the oil industry, overcoming the limitations of the conventional MPLC method.

### Methodology

The polar extraction method was adapted to a miniaturized sample preparation system based on the solid-phase extraction (SPE) process. The experiments were developed both offline, using a manifold apparatus, and online, using an automated SPE system.

Considering that the objective of the invention is the separation of polar compounds present in crude oils, a preliminary clean-up step to remove saturated and aromatic compounds was performed.

The automated sequential coupling multidimensional chromatograph consisted of 2 (two) untreated normal-phase silica cartridges, 2 (two) normal-phase silica cartridges treated with base (5% KOH) and 1 (one) normal-phase silica cartridge treated with acid (5% HCl). The cartridges were dry-packed and subsequently coupled to the extraction system in series: untreated silica cartridge (A), basic cartridge (B), acidic cartridge (C), basic cartridge (D), and untreated cartridge (E).

For SPE fractionation, five glass SPE cartridges with an internal volume of 15 mL were numbered A to E and packed with the same stationary phases used in the reference method, MPLC.

In this way, 15 mg of oil were solubilized in 1 mL of n-Hexane and applied to cartridge A, containing the untreated silica gel 60 stationary phase. Next, 8 mL of n-hexane were eluted into cartridge A, and the fraction collected under −15″ Hg vacuum containing saturated compounds was discarded. After discarding the saturated fraction, cartridge A was coupled to the other cartridges B to E arranged in series, in a vertical configuration (FIG. 4a), in a manifold (offline) instrument, or sequential multiposition in an online SPE instrument (FIG. 4).

The first mobile phase, consisting of a DCM:MeOH 99:1 mixture, was applied to cartridge A at a flow rate of 10 mL/min. Thus, the low-polarity compounds present in the sample were eluted with the mobile phase passing through all cartridges in sequence (the sample elutes from the first cartridge to the second, and so on).

At the end of the elutions, 15 mL were collected directly from cartridge E, corresponding to the low-polarity fraction. Then, using the same mobile phase system, 10 mL were also collected from cartridge E. And, corresponding to the low-medium polarity fraction. Finally, 10 mL of DCM:MeOH 95:5 were collected from cartridge E, corresponding to the high-medium polarity fraction. After obtaining the low, low-medium, and high-medium polarity fractions, the sequential system was disassembled, and the cartridges were isolated for the separation of the acidic, basic, and high polarity fractions.

Cartridge C (silica gel 60 treated with 5% HCl) was eluted with DCM:MeOH 95:5, collecting 7 mL of the basic fraction from cartridge D. The acidic fraction was obtained by eluting DCM:Formic acid 99:1 through cartridges B and D, collecting 7 mL of acidic fraction from cartridge D.

All fractionation steps were conducted at room temperature (25° C.). In the offline SPE extraction, the fractions were collected under a vacuum of −15″ Hg (7.33 psi) while a mass pressure of 12 psi was used for online SPE extraction.

The packing was performed dry, where 2 g of untreated silica (stationary phase) were packed into each cartridge—cartridges A and E containing untreated 230 to 240 mesh silica gel 60; cartridges B and D containing silica gel 60 treated with 5% KOH; and cartridge C containing silica gel 60 treated with 5% HCl—and arranged in series, in a vertical configuration (FIG. 4B) in a manifold apparatus and sequential multiposition in an online SPE apparatus (FIG. 4B), as shown in FIG. 4. Both fractionation systems proved efficient in separating the analytes of interest.

FIG. 4 depicts the components of the invention. Summarizing these components into experimental steps, the method consists of the following steps: I) sample preparation, II) application of the sample dissolved in n-Hexane to the cartridge (A) containing the normal-phase silica stationary phase, and III) separation of the fraction saturated with 100% n-Hexane from the cartridge (A).

For the multidimensional chromatographic fractionation of polar compounds (FIGS. 4 and 5), IV) sequential coupling of the SPE cartridges containing the stationary phases was performed, in the following order: basic silica cartridge (A); basic silica cartridge functionalized with KOH (B); acidic silica cartridge functionalized with HCl (C); basic silica cartridge functionalized with KOH (D); and untreated normal-phase silica cartridge (E).

The following steps consisted of extracting the polar compounds through V) elution of low (1—BP fraction) and low-medium (1—BMP fraction) polarity compounds using the DCM/MeOH 99:1 elution system, collected from cartridge (E); VI) elution and extraction of high-medium polarity compounds (2—AMP fraction) using the DCM/MeOH 95:5 elution system, collected from cartridge (E); VII) elution and extraction of basic compounds (4—BAS fraction) collected directly from cartridge (C) functionalized with HCl; VIII) elution and extraction of acidic compounds (5—ACD fraction) collected directly from cartridges (B) and (D) functionalized with KOH using the dichloromethane elution system in acidic medium (DCM/Formic acid 99:1).

The last fractionation step consisted of IX) elution and extraction of the high polarity compounds (3—AP fraction) directly from the cartridge (A) using the DCM/MeOH 70:30 system.

The next steps of the invention involved X) analysis and characterization of the fractions: acquisition of spectra by ESI (±) FT-ICR-MS and APPI (+) FT-ICR-MS of the six fractions, processing of the spectra, assignment of molecular formulas by Composer software (or another capable of assigning molecular formulas, such as PetroOrg) and class distribution using Thanus software (or other software used to generate graphs from spectrometric data, such as Origin®, PyC2MC, GitHub and Zenodo). HPLC grade solvents were used for the chromatographic fractionation and spectrometric analysis by FT-ICR-MS steps.

Finally, to evaluate the accuracy of the method, XI) experiments were performed in quintuplicate to determine the reproducibility of the SPE method through chromatographic fractionation of crude oil 220321735.

### Analyses and Characterizations of the Fractions Obtained by the Present Method

Detailed analysis of the chemical composition of oils and their derivatives allows inferences concerning their physicochemical properties and directly reflects information such as API gravity, heteroatom content (nitrogen and sulfur) and total acid content (TAN).

Ferreira et al. (2020) reported that non-basic nitrogen heterocyclic compounds are predominantly present in light and medium oils, while heavy oils have a greater abundance of compounds related to the Oz class. On the other hand, the evaluation of the molecular content of the crude oils in positive ionization mode (ESI (+)) led to the detection of basic nitrogen compounds (class N), which were predominant in all samples evaluated. ESI (+) also detected other nitrogen compounds, such as N₂, NO, NS and NOS, with a predominance of classes NOS and NS in oils S8 and S6, respectively.

In this context, the extraction of polar compounds from crude oils was carried out by means of chromatographic fractionation using solid phase extraction techniques (online SPE, employing an automated system, and offline, employing a vacuum collector for manifold-type SPE) and HMPLC. Chromatographic fractionation yielded six fractions of distinct polarities and acid/base characteristics (low polarity—BP, low-medium polarity—BMP, high-medium polarity—AMP, high polarity—AP, basic—BAS, acidic—ACD).

The Brazilian crude oils (provided by PETROBRAS for chromatographic fractionation) were analyzed by ESI (±) FT-ICR MS and APPI (+) FT-ICR MS to obtain a fingerprinting. In the ESI (+) analyses, the spectra showed m/z ranges from 150 to 2000, with more prominent relative abundances between m/z 300 to 500. For the APPI (+) FT-ICR MS spectra, the m/z ranges were also from 150 to 2000, with more prominent abundances between m/z 400 to 600.

### Repeatability of the Present Method

FIG. 2 shows the results of the repeatability assessment of the method in the extraction of low polarity (BP), low-medium polarity (BMP), high-medium polarity (AMP), high polarity (AP), basic (BAS) and acidic (ACD) compounds. These designations come from the MPLC polar fractionation methods, routinely used to separate the resin fraction of crude oil into different polarities and acidic/basic characteristics.

The principle of this technique is based on the differential affinity of substances between the different stationary and mobile phases, which are separated by chemical affinity [(Willsch, H.; Clegg, H.; Horsfield, B.; Radke, M.; Wilkes, H. Liquid Chromatographic Separation of Sediment, Rock, and Coal Extracts and Crude Oil into Compound Classes, Analytical Chemistry, 1997, 69, 4203 to 4209, Covas, T. R. et al., Fractionation of polar compounds from crude oils by heteromedium pressure liquid chromatography (H-MPLC) and molecular characterization by ultrahigh-resolution mass spectrometry, Fuel 267 2020, 117289)]. This methodology not only isolates polar compounds but also fractionates them by degree of polarity without preliminary asphaltene e removal steps. This methodology allowed for a reduction in resin complexity and the obtaining of fractions with the chemical classes of interest.

Using combined polarity/affinity chromatography with MPLC, the oils are subjected to this column chromatography to recover seven fractions. High, medium, and low polarity compounds, including aromatic and saturated hydrocarbons, are separated according to their polarity, while acids and bases are retained according to their affinity with basic and acidic modified silica.

For this experiment, 2 g of untreated silica were used in the SPE fractionation and 8 g of silica in the H-MPLC fractionation. The untreated silica is composed of silica gel 60, 230 to 400 mesh ASTM. The details of the stationary phases used in the fractionation are described in Table 1 below.

TABLE 1
Details of the stationary phases used
in the SPE or H-MPLC fractionation

| | | Column | | Partial |
|---|---|---|---|---|
| | MKW Partial | dimensions | Silica | number of |
| Column | Number | L × ID | particle | activated |
| type | Column | (mm × mm) | size (mm) | silica MKW |
| A | — | 150 × 10 | 0.063 to | M-07734-D |
| | | | 0.200 | |
| B and C | — | 150 × 10 | 0.063 to | SI-KOHG |
| | | | 0.200 | |
| D | — | 150 × 10 | 0.063 to | SI—HCL |
| | | | 0.200 | |
| E | H-6114-N | 250 × 10 | 0.040 to | — |
| | | | 0.063 | |

### Analyses Performed

The analyses of the five acidic fractions and the five low-polarity fractions by ESI (−) FT-ICR are represented in FIG. 3A, which shows a class distribution diagram for the acidic fraction highlighting the classes of oxygenated compounds (Classes O₂ and O₃), corresponding to the carboxylic acids, which are predominantly extracted in this fraction.

Furthermore, FIG. 3B also shows the classes of nitrogenous compounds (N, N₂, NO, NO₂ and NS) of the low-polarity fraction, both from oil S1. These results revealed the consistency of the method. The acidic fractions showed essentially the same abundance of the O₂ and O₃ classes, which are predominant in these fractions. The low-polarity fractions also presented the same classes with similar abundance, although they are more complex.

The class distribution diagram of the acidic and low-polarity fractions confirmed the efficiency of the extraction method, showing a consistent molecular content of oxygenated and nitrogenous compounds, with no variations greater than 5% in the relative abundance of heteroatomic classes.

These results indicated consistent trends between replicates, with low standard deviations, suggesting good precision in the SPE fractionation process. Thus, the chromatographic method demonstrated satisfactory repeatability, allowing the reliable separation of the crude oil components into distinct fractions for further analysis.

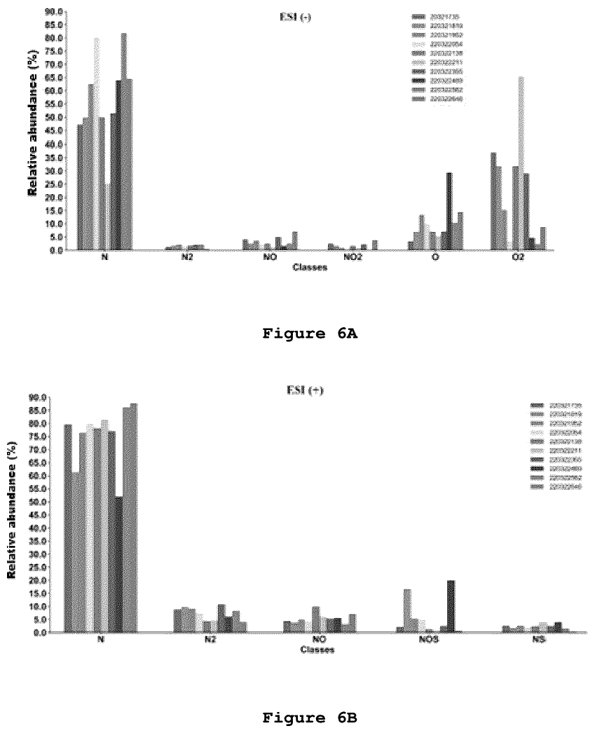

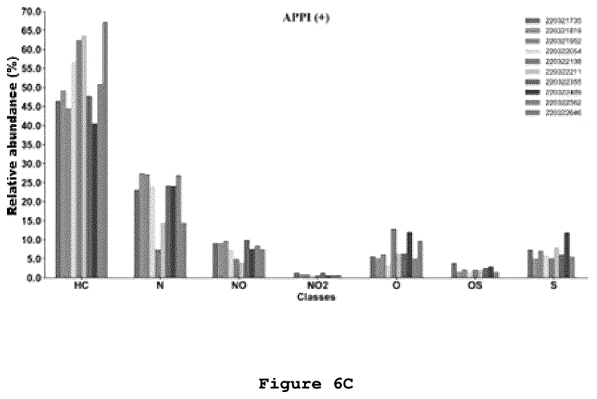

Furthermore, FIG. 6A shows the class distribution diagram by ESI (−) FT-ICR MS of five replicates of the SPE fractionation of the acidic and low-polarity fractions of oil S1. This data was obtained to evaluate the reproducibility of the SPE method through the chromatographic fractionation of crude oil.

The fractions, as well as the source oils, were characterized on an FT-ICR MS 7T Solarix instrument (Bruker, Germany) coupled to the ESI and APPI source (FIGS. 6A to 6C). Thus, FIGS. 6A, 6B and 6C illustrate the class distribution for the analyses by ESI (±) FT-ICR MS (FIGS. 6A and 6B) and APPI (+) FT-ICR MS (FIG. 6C) of the ten crude oil samples (S1 to S10).

According to the data showed for ESI (−), the highest detection is observed for non-basic nitrogen compounds, such as indoles and carbazoles, followed by compounds containing one and two oxygen atoms, class O and class O₂, respectively. From the class distribution graphs for the ESI analyses (−) (FIG. 6A), it was observed that the highest detection of non-basic nitrogen compounds was for oils S3, S4, S8, S9 and S10.

Among the samples analyzed, sample S9 showed the highest content of compounds belonging to class N (68.60%), followed by sample S4 (66.26%). In contrast, oils S5 and S1 showed the lowest nitrogen content, 13.77% and 28.74%, respectively. Oils S1, S2, S5, S6 and S7 predominantly showed compounds containing one and two oxygen atoms—class O and O₂, respectively. Oils S5 and S6 had the highest content of oxygenated compounds. For oil S1, 76.22% of the compounds accessed by ESI (−) belong to the aforementioned classes, while in S2, 65.36% correspond to compounds of class O. The oils with the lowest oxygen content are S9 (29.88%) and S4 (30.84%).

APPI (+) analyses revealed that oils S10, S6, and S5 had the highest levels of hydrocarbons (HC class), with a relative abundance greater than 60%. In contrast, oils S3 and S8 recorded the lowest levels, with a relative abundance below 45%. Regarding sulfur compounds (S and OS classes), they were identified in low abundance, below 15%, with oils S1 and S8 exhibiting the highest relative abundances in this category. Oils S5 and S6 stood out for the lowest levels in the N and NO classes (FIG. 6C).

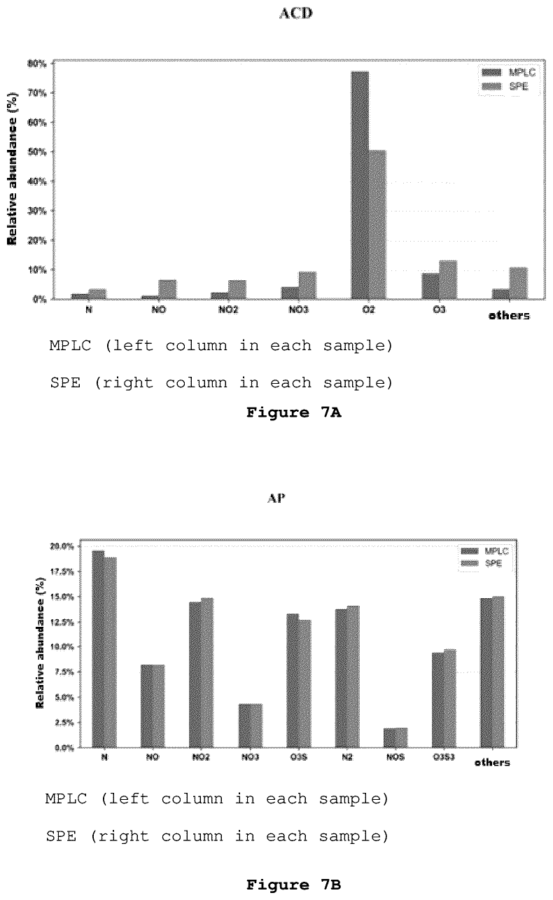

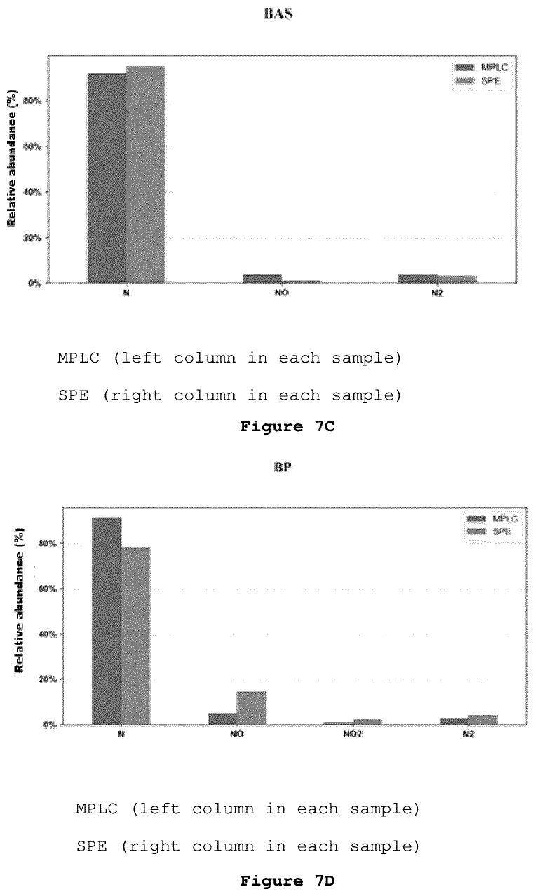

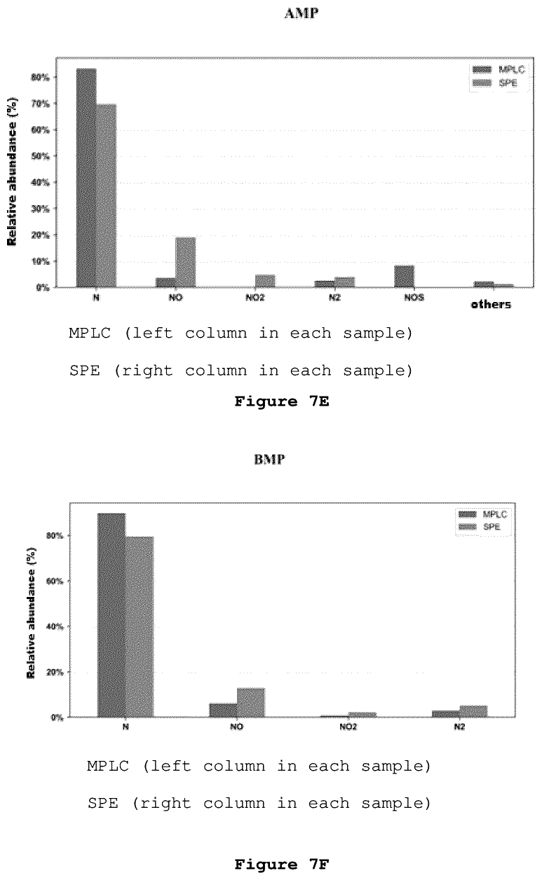

Additionally, FT-ICR MS analyses were also employed to evaluate the fractions obtained from both separation techniques, which were compared based on the extracted chemical classes in order to assess the efficiency of polar extraction techniques (N, S, and O classes), whose results are represented in FIGS. 7A to 7F.

The acidic fraction (7A) exhibited a differentiated profile based on the abundance of extracted species between the two techniques, with the results showing that extraction by H-MPLC was more selective for the extraction of the O₂ class, while extraction by SPE extracted a higher content of the N, NO and O₃ classes. However, very similar profiles for the basic fractions (7C) were observed using both techniques. The same behavior was observed for the low polarity (BP—7D), low-medium polarity (BMP—7F) and high-medium polarity (AMP—7E) fractions, with subtle variations in the abundance of the identified classes (FIG. 7). The fractionation performed for oil S10 showed that separation by SPE accurately reproduced the results obtained by fractionation by H-MPLC.

Summarizing the results obtained from both fractions, it is evident that the miniaturization process of crude oil fractionation using solid-phase extraction produced satisfactory results and can be successfully employed for the extraction of polar compounds from petroleum.

Those skilled in the art will appreciate the knowledge shown here and may reproduce the invention in the embodiments indicated and in other variants, encompassed within the scope of the appended claims.

1. A miniaturized chromatographic method for selective extraction of polar compounds from crude oils by solid-phase extraction (SPE) in online and offline modes coupled with medium-pressure liquid heterochromatography (H-MPLC), the method comprising the following steps:
i) sample preparation;
ii) application of the sample dissolved in n-hexane to a cartridge (A) containing a normal-phase silica stationary phase; and
iii) separation of a fraction saturated with 100% n-hexane from the cartridge (A).

2. The method of claim 1, wherein the method comprises using an automated multidimensional solid-phase extraction chromatographic system in online mode and using a manifold-type vacuum collector for solid-phase extraction in offline mode.

3. The method of claim 2, wherein the method further comprises:
(iv) in the online mode, a chromatographic fractionation of polar compounds is carried out with an automated multidimensional chromatographic system by sequentially coupling SPE cartridges containing stationary phases in the following order:
a basic silica cartridge (A);
a basic silica cartridge functionalized with KOH (B);
an acidic silica cartridge functionalized with HCl (C);
a basic silica cartridge functionalized with KOH (D); and
an untreated normal phase silica cartridge (E).

4. The method of claim 3, wherein the chromatographic fractionation of the polar compounds provides six distinct fractions based on polarity and acid-base characteristics defined by elution systems used comprising:
a low polarity (BP) fraction, extracted with a dichloromethane/methanol (DCM/MeOH) mixture at 99:1 (v/v);
a low-medium polarity (BMP) fraction, extracted sequentially with the dichloromethane/methanol mixture at 99:1 (v/v);
a high-medium polarity (AMP) fraction, extracted with a dichloromethane/methanol mixture at 95:5 (v/v);
a high polarity (AP) fraction, extracted with a dichloromethane/methanol mixture at 7:3 (v/v);
a basic (BAS) fraction, extracted with the dichloromethane/methanol mixture at 95:5 (v/v) in neutral medium from a cartridge with an acidic stationary phase comprising silica functionalized with HCl; and
an acidic (ACD) fraction, extracted with dichloromethane in acidic medium comprising a dichloromethane/formic acid mixture at 99:1 (v/v) from a cartridge with a basic stationary phase comprising silica functionalized with KOH.

5. The method of claim 4, wherein the method further comprises:
(v) elution of low polarity compounds in the low polarity (BP) fraction and the low-medium polarity compounds in the low-medium polarity (BMP) fraction using the DCM/MeOH mixture at 99:1 (v/v) elution system, collected from cartridge (E);
(vi) elution and extraction of high-medium polarity compounds in the high-medium polarity (AMP) fraction using the DCM/MeOH mixture at 95:5 (v/v) elution system, collected from cartridge (E);
(vii) elution and extraction of basic compounds in the basic (BAS) fraction collected directly from cartridge (C) functionalized with HCl;
(viii) elution and extraction of acidic compounds in the acidic (ACD) fraction collected directly from cartridges (B) and (D) functionalized with KOH, using the dichloromethane elution system in acidic medium comprising the dichloromethane/formic acid mixture at 99:1 (v/v); and
(ix) elution and extraction of high polarity compounds in the high polarity (AP) fraction directly from cartridge (A) using the DCM/MeOH mixture at 7:3 (v/v).

6. The method of claim 5, the method further comprises:
(x) analysis and characterization of the fractions by acquisition of spectra by ESI (±) FT-ICR MS and APPI (+) FT-ICR MS of the six fractions, processing of the spectra, assignment of molecular formulas and distribution of classes,
wherein HPLC grade solvents (99.9%) are used in the chromatographic fractionation and spectrometric analysis by FT-ICR-MS.

7. The method of claim 6, wherein in the ESI (+) FT-ICR MS spectra, the m/z ranges are from 150 to 2000, with more prominent relative abundances between m/z 300 to 500; and in the APPI (+) FT-ICR MS spectra, the m/z ranges are from 150 to 2000, with the more prominent relative abundances between m/z 400 and 600.

8. The method of claim 2, wherein in the online SPE extraction a pressure of 12 psi is used, and in the offline SPE extraction the fractions are collected under a vacuum of 7.33 psi.

9. The method of claim 1, wherein all fractionation steps are carried out at room temperature (25° C.).

10. An automated multidimensional solid-phase extraction chromatographic system configured to operate according to the miniaturized chromatographic method as defined in claim 1, the system comprising:
two untreated normal-phase silica cartridges (i.e., untreated silica cartridge),
two normal-phase silica cartridges treated with a base comprising 5% KOH (i.e., basic cartridge); and
one normal-phase silica cartridge treated with an acid comprising 5% HCl (i.e., acid cartridge),
wherein the cartridges are dry-packed and subsequently coupled to an extraction system in series in the following order: untreated silica cartridge (A), basic cartridge (B), acid cartridge (C), basic cartridge (D), and untreated silica cartridge (E).

11. The system of claim 10, whereinafter the addition of n-Hexane to cartridge A, cartridge A is coupled to cartridges B, C, D and E, arranged in sequence.

12. The system of claim 10, wherein all fractionation steps are conducted at room temperature (25° C.).

13. A method of using the method of claim 1, comprising employing the method for at least one of: advanced molecular analysis, geochemical characterization, development of
